(19) United States
(12) Patent Application Publication
(10) Pub. No.: US 2014/0226535 A1
(43) Pub. Date: Aug. 14, 2014

(54) Methods and Apparatus for Configuring and Implementing IP Multimedia Subsystem Supplementary Services

(71) Applicants: Mikael Forsberg, Tyreso (SE); László Balla, Pomaz (HU)

(72) Inventors: Mikael Forsberg, Tyreso (SE); László Balla, Pomaz (HU)

(73) Assignee: TELEFONAKTIEBOLAGET L M ERICSSON (PUBL), Stockholm (SE)

(21) Appl. No.: 14/343,589

(22) PCT Filed: Sep. 15, 2011
(86) PCT No.: PCT/EP2011/066045

§ 371 Date: Mar. 19, 2014

(51) Int. Cl. H04L 29/06; H04W 4/16

(52) U.S. Cl. CPC H04L 65/1016; H04W 4/16; H04L 65/1006
USPC 370/259

(57) ABSTRACT

According to a first aspect of the present invention there is provided a method of operating an Application Server (AS) that implements an IP Multimedia Subsystem (IMS) supplementary service for a user. The method comprises configuring a rule for the user, the rule having a condition that defines a Session Initiation Protocol (SIP) header field and defines a value of the SIP header field that must be matched by a SIP message in order to meet the condition. The method further comprises determining if the condition is met by a SIP message relating to the user and thereby determining if an action associated with the rule should be performed in relation to the SIP message.

### TECHNICAL FIELD

The present invention relates to methods and apparatus for configuring and implementing an IP Multimedia Subsystem (IMS) supplementary service. More particularly, the invention relates to methods and apparatus for enabling an IP Multimedia Subsystem (IMS) user to flexibly configure their supplementary services.

### BACKGROUND

IP Multimedia Subsystem (IMS) is the technology defined by the Third Generation Partnership Project (3GPP) to provide IP Multimedia services over mobile communication networks. IMS provides key features to enrich the end-user person-to-person communication experience through the integration and interaction of services. IMS allows new rich person-to-person (client-to-client) as well as person-to-content (client-to-server) communications over an IP-based network. The IMS makes use of the Session Initiation Protocol (SIP) to set up and control calls or sessions between user terminals (or user terminals and application servers). The Session Description Protocol (SDP), carried by SIP signalling, is used to describe and negotiate the media components of the session. Whilst SIP was created as a user-to-user protocol, IMS allows operators and service providers to control user access to services and to charge users accordingly. Other protocols are used for media transmission and control, such as Real-time Transport Protocol and Real-time Transport Control Protocol (RTP/RTCP),

FIG. 1 illustrates schematically how the IMS fits into the mobile network architecture in the case of a GPRS/PS access network (IMS can of course operate over other access networks). As shown in FIG. 1, the IMS includes a core network and a service network. Call/Session Control Functions (CSCFs) operate as SIP proxies within the IMS core network, and interface with other entities such as Border Gateway Control Functions (BGCFs) and Media Resource Function Controllers (MRFCs) amongst others. A Proxy CSCF (P-CSCF) is the first point of contact within the IMS for a SIP terminal; a Serving CSCF (S-CSCF) provides services to the subscriber; an Interrogating CSCF (I-CSCF) identifies the correct S-CSCF and forwards to that S-CSCF a request received from a SIP terminal via a P-CSCF.

Within the IMS service network, Application Servers (ASs) are provided for implementing IMS service functionality. Application Servers provide services to end users in an IMS system, and may be connected either as end-points over the 3GPP defined Mr interface, or “linked in” by an S-CSCF over the 3GPP defined ISC interface. In the latter case, Initial Filter Criteria (IFC) are used by an S-CSCF to determine which Applications Servers should be “linked in” during a SIP Session establishment (or indeed for the purpose of any SIP method, session or non-session related). The IFCs are received by the S-CSCF from an HSS during the IMS registration procedure as part of a user's Subscriber Profile.

3GPP TS 22.173 (V11.2.0) and 3GPP TS 24.173 (V10.0.0) define the supplementary services that are supported by IMS. For example, the standardized supplementary services supported by IMS include but are not limited to Originating Identification Presentation (OIP), Originating Identification Restriction (OIR), Terminating Identification Presentation (TIP), Terminating Identification Restriction (TIR), Communication Diversion (CDIV), Communication Hold (HOLD), Communication Barring (CB), Message Waiting Indication (MWI), Conference (CONF), Advice Of Charge (AOC), Communication Waiting (CW), Flexible Alerting, Customized Alerting Tones (CAT), and Customized Ringing Signal (CRS). In addition to the standardized supplementary services, the vendor of an IMS Application Server can configure an Application Server so as to implement additional, vendor specific services. An example of such a vendor specific service is the Flexible Communication Distribution service.

The CONFerence (CONF) service, as defined in 3GPP TS 24.147 (V10.1.0) and 3GPP TS 24.605 (V10.0.0), enables a user to participate in and control a simultaneous communication involving a number of users. 3GPP TS 24.147 specifies (in section 5.3.1.3) how an IMS user can create a conference call and invite other users to the conference. For example, to create a conference, a UE can generate an initial SIP INVITE request and set the request URI of the INVITE request to the conference factory URI of a conference focus (i.e. an entity that has the ability to host conferences). In order to invite other user's to join the conference, the UE can then either send a REFER request to the user directly, with the Refer-To header of the REFER request set to the conference URI of the conference, or can send a REFER request to the conference focus, with the Refer-To header of the REFER request set to the SIP URI or tel URL of the user who is invited to the conference. As an alternative example, in order to create a conference, a UE can generate a SIP INVITE request that is sent to the conference focus using the conference factory URI, and can attach a message body to the request that includes a URI list that identifies the other users that are to be invited to the conference.

Upon receipt of either a REFER request that requests that other users are invited to a conference or an INVITE request that creates a conference and includes a list of other users that are to be invited to the conference, the conference focus can invite users to the conference by sending either an INVITE request or a REFER request to the invited user(s), the request including the conference URI of the conference. Following receipt of either an INVITE request or a REFER request from the conference focus at the UE of an invited user, the invited user can then decide whether or not to accept the invitation and join the conference. In order to join the conference, the UE of the invited user can then generate and send an INVITE request with the request URI of the INVITE request set to the conference URI received from the conference focus in the INVITE request or REFER request.

It has been recognised here that a user who is invited to join a conference may have a subscription to the Communications Diversion (CDIV) service, as defined in 3GPP TS 24.604 (V10.1.0), which enables the user to divert/re-direct an incoming communication that fulfils certain provisioned or configured conditions to another destination. In particular, it has been recognised that a user who subscribes to the Communications Diversion (CDIV) service will often configure the service to redirect all incoming communications to a voicemail system. Consequently, when an INVITE request is sent toward the user's UE by a conference focus, in order to invite the user to join a conference, the Communications Diversion (CDIV) service will redirect the request to the voicemail system, which will undesirably result in the voicemail system joining the conference and recording at least part of the conference session. Furthermore, this is a problem that has not been recognised in the 3GPP standards, as both 3GPP TS 24.605 (V10.0.0) defining the CONFerence (CONF) service and 3GPP TS 24.604 (V10.1.0) defining the Communications Diversion (CDIV) service specifically state that these services have no impact on one another (see 3GPP TS 24.605 (V10.0.0) section 4.6.7 and 3GPP TS 24.604 (V10.1.0) section 4.6.6).

In order to avoid this problem, the user could consider configuring their Communications Diversion (CDIV) service with a communication diversion rule where a condition of the rule causes the corresponding action to be triggered by the presence of the conference URI in the request. In this regard, the current 3GPP specifications that relate to rule based supplementary services define a limited set of rule conditions for evaluating the rules that are applicable to the service. These conditions include the “cp:identity” condition, whose value is matched against the value taken from the P-Asserted-Identity header field, the From header field, the Referred-By header field, or the Contact header field when GRUU is used. Such a rule would therefore be required to include the “cp:identity” condition with the value of the condition being set to the conference URI. The action of this communication diversion rule would then ensure that the request is redirected to a target other than the voicemail system.

There are two problems with this approach. Firstly, in order to ensure that this communication diversion rule would be triggered for a conference request, the user would have to be aware of the conference URI before receiving the invitation from the conference focus. However, the user will not be aware of the conference URIs that could be used by a conference focus as this is not usually publicly available. In any case, even if the user could obtain some conference URIs, these could only be the conference URIs used by the user's home network and not the conference URIs of all network operators. Secondly, some conference servers (i.e. application servers that can implement a conference focus) are configured to set the P-Asserted-Identity header of the request to the identity of the inviting user, rather than the conference URI. A conference server may be configured in this way in order to inform the invited user of the identity of the inviting user. Alternatively, a conference server may be configured in this way if the inviting user is to be charged for the conference session, such that the P-Asserted-Identity header can be used to identify the inviting user for charging purposes.

It has also been recognised here that the same limitations also apply to the Incoming Communication Barring (ICB) service of the Communication Barring (CB) service, as defined in 3GPP TS 24.611 (V10.0.0). In particular, according to the current 3GPP standards, it is not practically possible for a user to configure a communication barring rule that rejects incoming communications that relate to a conference session, as to do so the user would have to configure the communication barring rule with the all possible conference URIs. This is a problem that has not been recognised in the 3GPP standards, as both 3GPP TS 24.605 (V10.0.0) defining the CONFerence (CONF) service and 3GPP TS 24.611 (V10.0.0) defining the Communication Barring (CB) service only consider the impact of Outgoing Communication Barring (OCB) rules on the CONFerence (CONF) service (see 3GPP TS 24.605 (V10.0.0) section 4.6.9 and 3GPP TS 24.611 (V10.0.0) section 4.6.6).

### SUMMARY

It is therefore an object of the present invention to enable an IP Multimedia Subsystem (IMS) user to configure their supplementary services, such as the Communications Diversion (CDIV) service and Communication Barring (CB) service, to handle incoming communications that relate to a conference.

According to a first aspect of the present invention there is provided a method of operating an Application Server (AS) that implements an IP Multimedia Subsystem (IMS) supplementary service for a user. The method comprises configuring a rule for the user, the rule having a condition that defines a Session Initiation Protocol (SIP) header field and defines a value of the SIP header field that must be matched by a SIP message in order to meet the condition. The method further comprises determining if the condition is met by a SIP message relating to the user and thereby determining if an action associated with the rule should be performed in relation to the SIP message.

According to a second aspect of the present invention there is provided a method of operating a user equipment (UE) to configure an IP Multimedia Subsystem (IMS) supplementary service for a user. The method comprises accepting input from the user, the input defining a rule for the user, the rule having a condition that defines a SIP header field and defines a value of the SIP header field that must be matched by a SIP message in order to meet the condition, and an action to be performed in relation to the SIP message if the condition is met. The method further comprises sending a message to an Application Server (AS) that implements the supplementary service, the message including the rule defined by the user input.

These methods enable a rule-based supplementary service to be configured with rules having a generic condition, this generic condition enabling actions to be triggered if a defined SIP header field is present or if the value of a defined SIP header field matches a value that is also defined in the condition, providing much greater flexibility in the definition of rules that can be implemented by IMS rule based services.

The supplementary service may be any one of a Communications Diversion (CDIV) service, a Communication Barring (CB) service, a Flexible Alerting service, a Flexible Communication Distribution, and any other rule based service.

The rule may be configured with a condition that requires a SIP message to have a Contact header field and requires a value of the Contact header field to include an isfocus feature parameter.

According to a third aspect of the present invention there is provided a method of operating an IP Multimedia Subsystem (IMS) Application Server (AS) that implements a supplementary service for a user. The method comprises configuring a rule for the user, the rule having a condition specifying whether or not a Contact header field of a SIP message must include an isfocus feature parameter. The method further comprises determining if a Contact header field of a SIP message relating to the user includes the isfocus feature parameter and thereby determining if an action supported by the supplementary service and associated with the rule should be performed in relation to the SIP message.

The AS may be configured to implement any one of a Communications Diversion (CDIV) service, a Communication Barring (CB) service, a Flexible Alerting service, a Flexible Communication Distribution, and any other rule based service.

The AS may be configured to implement a Communications Diversion (CDIV) service and may be configured with a rule that determines whether or not to re-direct a SIP message intended for the user. The rule may determine whether or not to re-direct a SIP INVITE request inviting a user to join a conference.

The AS may be configured to implement a Communication Barring (CB) service and may be configured with a rule that determines whether or not to reject a SIP message intended for the user. The rule may determine whether or not to reject a SIP INVITE request inviting a user to join a conference.

According to a fourth aspect of the present invention there is provided a method of operating a user equipment (UE) to configure an IP Multimedia Subsystem (IMS) supplementary service for a user. The method comprises accepting input from the user, the input defining a rule for the user, the rule having a condition specifying whether or not a Contact header field of a SIP message must include an isfocus feature parameter, and an action to be performed in relation to the SIP message if the condition is met. The method further comprises sending a message to an Application Server (AS) that implements the supplementary service, the message including the rule defined by the user input.

The UE may be configured to allow the user to configure a Communications Diversion (CDIV) service with a rule that determines whether or not to re-direct a SIP message intended for the user. The rule may determine whether or not to re-direct a SIP INVITE request inviting a user to join a conference.

The UE may be configured to allow the user to configure a Communication Barring (CB) service with a rule that determines whether or not to reject a SIP message intended for the user. The rule may determine whether or not to reject a SIP INVITE request inviting a user to join a conference.

These methods enable a rule-based supplementary service to be configured with rules having a condition that enable actions to be triggered by the presence or absence of the “isfocus” parameter in the Contact header field. For example, such a condition could therefore be used to ensure that an invitation to join a conference is either diverted or not diverted by a rule in the case of the Communications Diversion service, and to ensure that an invitation to join a conference is either allowed or rejected by a rule in the case of the Communication Barring service.

According to a fifth aspect of the present invention there is provided an apparatus configured to operate as an Application Server (AS) that implements an IP Multimedia Subsystem (IMS) supplementary service for a user. The apparatus comprises a memory for storing a rule for the user, the rule having a condition that defines a SIP header field and defines a value of the SIP header field that must be matched by a SIP message in order to meet the condition. The apparatus further comprises a processor for determining if the condition is met by a SIP message relating to the user and thereby determining if an action associated with the rule should be performed in relation to the SIP message.

The AS may be configured to implement any one of a Communications Diversion (CDIV) service, a Communication Barring (CB) service, a Flexible Alerting service, a Flexible Communication Distribution, and any other rule based service.

The memory may be configured with a rule having a condition that requires a SIP message to have a Contact header field and requires the value of the Contact header field to include an isfocus feature parameter.

According to a sixth aspect of the present invention there is provided an apparatus configured to operate as a user equipment (UE) that enables a user to access an IP Multimedia Subsystem (IMS). The apparatus comprises a user input device, a processor for accepting input from the user input device, the input defining a rule for the user that is to be applied by a supplementary service, the rule having a condition that defines a SIP header field and defines a value of the SIP header field that must be matched by a SIP message in order to meet the condition, and an action to be performed in relation to the SIP message if the condition is met, and a transmitter for sending a message to an Application Server (AS) that implements the supplementary service, the message including the rule defined by the user input.

The transmitter may be further configured to send the message to an AS that implements a supplementary service that is any one of a Communications Diversion (CDIV) service, a Communication Barring (CB) service, a Flexible Alerting service, a Flexible Communication Distribution, and any other rule based service.

The processor may be further configured to accept input of a rule having a condition that requires a SIP message to have a Contact header field and requires the value of the Contact header field to include an isfocus feature parameter.

According to a seventh aspect of the present invention there is provided an apparatus configured to operate as an IP Multimedia Subsystem (IMS) Application Server (AS) that implements a supplementary service for a user. The apparatus comprises a memory for storing a rule for the user, the rule having a condition specifying whether or not a Contact header field of a SIP message must include an isfocus feature parameter. The apparatus further comprises a processor for determining if a Contact header field of a SIP message relating to the user includes the isfocus feature parameter as is required the rule and thereby determining if an action associated with the rule should be performed in relation to the SIP message.

The AS may be configured to implement any one of a Communications Diversion (CDIV) service, a Communication Barring (CB) service, a Flexible Alerting service, a Flexible Communication Distribution, and any other rule based service.

The AS may be configured to implement a Communications Diversion (CDIV) service. The processor may then be further configured to apply the rule to determine whether or not to re-direct a SIP message intended for the user. The processor may be further configured to apply the rule to determine whether or not to re-direct a SIP INVITE request inviting a user to join a conference.

The AS may be configured to implement a Communication Barring (CB) service. The processor may then be further configured to apply the rule to determine whether or not to reject a SIP message intended for the user. The processor may be further configured to apply the rule to determine whether or not to reject a SIP INVITE request inviting a user to join a conference.

According to a eighth aspect of the present invention there is provided an apparatus configured to operate as a user equipment (UE) that enables a user to access an IP Multimedia Subsystem (IMS). The apparatus comprises a user input device, a processor for accepting input from the user input device, the input defining a rule for the user that is to be applied by a supplementary service, the rule having a condition specifying whether or not a Contact header field of a SIP message must include an isfocus feature parameter, and an action to be performed in relation to the SIP message if the condition is met. The apparatus further comprises a transmitter for sending a message to an Application Server (AS) that implements the supplementary service, the message including the rule defined by the user input.

The transmitter may be further configured to send the message to an AS that implements a supplementary service that is any one of a Communications Diversion (CDIV) service, a Communication Barring (CB) service, a Flexible Alerting service, a Flexible Communication Distribution, and any other rule based service.

### BRIEF DESCRIPTION OF THE DRAWINGS

FIG. 1 schematically an IMS network in association with a mobile network architecture of a General Packet Radio Service (GPRS) access network;

FIG. 2 is a flow diagram illustrating an example of the process of configuring and implementing an IP Multimedia Subsystem (IMS) supplementary service in accordance with the methods described herein;

FIG. 3 illustrates schematically an example of an Application Server suitable for implementing the methods described herein; and

FIG. 4 illustrates schematically an example of a User Equipment suitable for implementing the methods described herein.

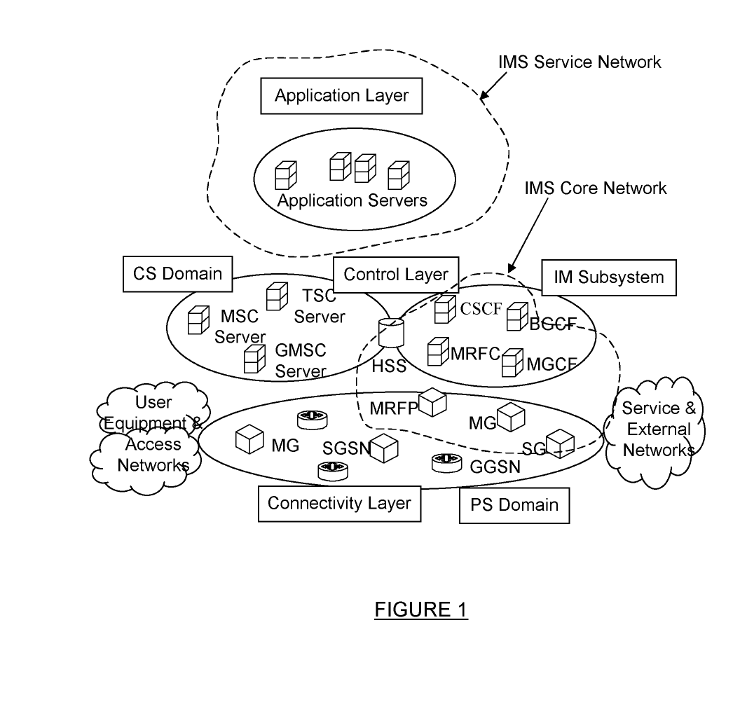

### DETAILED DESCRIPTION

In order to at least mitigate the problems identified above there will now be described a method of enabling an IP Multimedia Subsystem (IMS) user to configure their supplementary services, such as the Communications Diversion (CDIV) service and Communication Barring (CB), to handle incoming communications that relate to a conference. The method involves configuring an Application Server (AS) that implements a supplementary service with a rule for determining if an action supported by the supplementary service should be performed, the rule having a condition specifying whether or not the Contact header field of a SIP message must include the isfocus feature parameter. In other words, the rule has a condition that is only met if the SIP message includes the Contact header field and the value of Contact header field must include the “isfocus” feature parameter. In doing so, this method provides that an AS implementing a supplementary service, such as Communications Diversion or Communication Barring, can be configured with a rule that is matched by a SIP message whose Contact header field contains the “isfocus” feature parameter. The “isfocus” feature parameter is added to the Contact header field by a conference focus when sending an INVITE request to a user who is invited to a conference. Such a rule can therefore enable the AS to trigger actions if an incoming communication relates to a conference.

To implement this method, the rule syntax as specified by IETF RFC 4745 would be extended to define additional condition elements. By way of example, one of these additional condition elements could take the form:
<isfocus>

This condition would evaluate to TRUE when the content of the defined Contact header field contains the “isfocus” feature parameter. In addition, to provide further flexibility to the definition of the rules that can be applied by a supplementary service, another additional condition element could take the form:
<no-isfocus>

This condition would evaluate to TRUE when the content of the defined Contact header field does not contain the “isfocus” feature parameter.

Extending the available conditions in this way would enable IMS rule based services to be trigger by the presence or absence of the “isfocus” parameter in the Contact header field, and could therefore be used to ensure that an invitation to join a conference is either diverted or not diverted by a rule in the case of the Communications Diversion service, and to ensure that an invitation to join a conference is either allowed or rejected by a rule in the case of the Communication Barring service.

Alternatively, this method could also be implemented by configuring an Application Server (AS) that implements a supplementary service with a rule for determining if an action supported by the supplementary service should be performed, the rule having a condition that defines a SIP header field and defines a value of the SIP header field that must be matched by a SIP message in order to meet the condition. In other words, the rule has a condition that is only met if the SIP message includes the SIP header field defined in the condition and the value of that SIP header field matches/is equal to a value that is also defined in the condition. In doing so, this method also provides that an AS implementing a supplementary service, such as Communications Diversion or Communication Barring, can be configured with a rule that is matched by a SIP message whose Contact header field contains the “isfocus” feature parameter. In addition, this method also provide a generic condition that can be used to configure rules that are triggered if a defined SIP header field is present or if the value of a defined SIP header field matches a value that is also defined in the condition, providing much greater flexibility in the definition of rules that can be implemented by IMS rule based services.

To implement this alternative method, the rule syntax as specified by IETF RFC 4745 would be extended to define additional condition elements. By way of example, one of these additional condition elements could take the form:
<sip-header id=“sip_header” value=“regExp”/>

This condition would evaluate to TRUE when the content of the defined SIP header field matches the value defined in the condition. The <sip-header id> element would be used to define the SIP header field that must be matched, and the <value> element would be used to define a regular expression that must be matched by the value of the defined SIP header field. For example, to identify a communication from a conference focus, this condition could be configured as:
<sip-header id=“Contact” value=“*.isfocus.*”/>

In addition, to provide further flexibility in the definition of these rules, another additional condition element could take the form:
<except-sip-header id=“sip_header” value=“regExp”/>

This condition would evaluate to FALSE when the content of the defined SIP header field matches the value defined in the condition. As described above, the <except-sip-header id> element would be used to define the SIP header field that must be matched, and the <value> element would be used to define a regular expression that must be matched by the value of the defined SIP header field.

By way of example, the XML schema used to define the additional condition elements described above could take the form:

```
<?xml version=″1.0″ encoding=″UTF-8″?>
<xs:schema targetNamespace=″urn:ietf:params:xml:ns:sip-header″
xmlns=″urn:ietfparams:xml:ns:sip-header″
xmlns:xs=″http://www.w3.org/2001/XMLSchema″ elementFormDefault=
″qualified″
attributeFormDefault=″unqualified″>
  <xs:annotation>
    <xs:documentation xml:lang=″en″>
    Adds the isfocus, no-isfocus, sip-header and except-sip-header
    elements to the conditionsType of the RFC 4745 Common Policy.
    </xs:documentation>
  </xs:annotation>
  <xs:element name=″isfocus″ type=″empty-element-type″>
    <xs:annotation>
      <xs:documentation>
      This defines a condition that evaluates to TRUE when the
      Contact header contains isfocus parameter.
      </xs:documentation>
    </xs:annotation>
  </xs:element>
  <xs:element name=″no-isfocus″ type=″empty-element-type″>
    <xs:annotation>
      <xs:documentation>
      This defines a condition that evaluates to TRUE when the
      Contact header does not contain isfocus parameter.
      </xs:documentation>
    </xs:annotation>
  </xs:element>
  <xs:element name=″sip-header″ type=″sip-header-type″>
    <xs:annotation>
      <xs:documentation>
      This defines a condition that evaluates to TRUE when it
      matches on the content of a SIP header.
      </xs:documentation>
    </xs:annotation>
  </xs:element>
  <xs:element name=″except-sip-header″ type=″sip-header-type″>
    <xs:annotation>
      <xs:documentation>
      This defines a condition that evaluates to FALSE when it
      matches on the content of a SIP header.
      </xs:documentation>
    </xs:annotation>
  </xs:element>
  <xs:complexType name=″sip-header-type″>
    <xs:attribute name=″id″ type=″xs:string″ use=″required″>
      <xs:annotation>
        <xs:documentation>
        The name of the SIP header.
        </xs:documentation>
      </xs:annotation>
    </xs:attribute>
    <xs:attribute name=″value″ type=″xs:string″ use=″optional″
    default=″.*″>
      <xs:annotation>
    <xs:documentation>
    The value of the SIP header specified as a
    regExp.
    </xs:documentation>
      </xs:annotation>
    </xs:attribute>
  </xs:complexType>
  <xs:complexType name=″empty-element-type″/>
</xs:schema>
```

Based on the above example XML schema defining the additional condition elements described above, these additional condition elements can then be used to define a Communication Diversion rule that prevents an INVITE request sent by a conference focus to user in order in invite the user to join a conference from being diverted. For example, such a rule could take the form:

```
<ss:communication-diversion active=″true″>
  <cp:ruleset>
    <cp:rule id=″Immediate non-conference″>
      <cp:conditions>
        <sh:no-isfocus/>
      </cp:conditions>
      <cp:actions>
        <forward-to>
          <target>sip:user_C@example.com</target>
        </forward-to>
      </cp:actions>
    </cp:rule>
  </cp:ruleset>
</ss:communication-diversion>
```

In addition, these additional condition elements can also be used to define a Commmunication Diversion rule that redirects an INVITE request sent by a conference focus to user in order in invite the user to join a conference to a different target from that to INVITE requests that do not relate to a conference. For example, such a rule could take the form:

```
<ss:communication-diversion active=″true″>
  <cp:ruleset>
    <cp:rule id=″Immediate with another target for conference″>
      <cp:conditions>
        <sh:isfocus/>
      </cp:conditions>
      <cp:actions>
        <forward-to>
          <target>sip:confernce_C@example.com</target>
        </forward-to>
      </cp:actions>
    </cp:rule>
    <cp:rule id=″Immediate non-conference″>
      <cp:conditions>
        <sh:no-isfocus/>
      </cp:conditions>
      <cp:actions>
        <forward-to>
          <target>sip:user_C@example.com</target>
        </forward-to>
      </cp:actions>
    </cp:rule>
  </cp:ruleset>
</ss:communication-diversion>
```

Similarly, these additional condition elements can also be used to define a Commmunication Barring rule that rejects/bars an INVITE request sent by a conference focus to user in order in invite the user to join a conference. For example, such a rule could take the form:

```
<ss:incoming-communication-barring>
  <cp:ruleset>
    <cp:rule id=″icb, conference″>
      <cp:conditions>
        <sh:isfocus/>
        </cp:identity>
      </cp:conditions>
      <cp:actions>
        <ss:allow>false</ss:allow>
      </cp:actions>
    </cp:rule>
  </cp:ruleset>
</ss:incoming-communication-barring>
```

Furthermore, as an example of the flexibility that is provided by the generic SIP header field condition defined above, this generic SIP header field condition can be used to define a Commmunication Barring rule that rejects/bars an incoming SIP message sent by a WLAN network. For example, such a rule could take the form:

```
<ss:incoming-communication-barring>
  <cp:ruleset>
    <cp:rule id=″icb, wlan″>
      <cp:conditions>
        <sh:sip-headerid=″P-Access-Network-Information″ value=
        ″wlan.*″/>
      </cp:conditions>
      <cp:actions>
        <ss:allow>false</ss:allow>
      </cp:actions>
    </cp:rule>
  </cp:ruleset>
</ss:incoming-communication-barring>
```

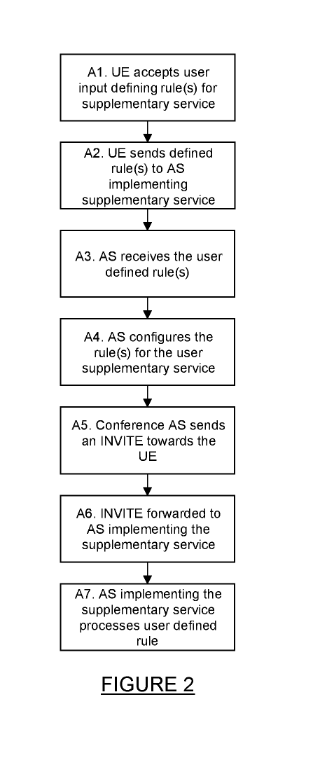

FIG. 2 is a flow diagram illustrating an example of the process of configuring and implementing an IP Multimedia Subsystem (IMS) supplementary service in accordance with the methods described herein. The steps performed are as follows:
A1. A user who wants to configure a supplementary service to which they have subscribed with makes use of their UE to input the rules that are to be applied by the supplementary service. For example, the user could configure a rule that defines a SIP header field and defines a value of the SIP header field that must be matched by a SIP message in order to meet the condition. As an alternative example, the user could configure a rule having a condition that specifies whether or not a Contact header field of a SIP message must include an isfocus feature parameter.
A2. The UE then sends a message to an AS that implements the supplementary service, the message including the rule defined by the user input. As specified in 3GPP TS 24.623, this configuration of supplementary services by the user could take place over the Ut interface using XCAP as the enabling protocol, or could use SIP based user configuration.
A3. The AS that implements the supplementary service receives the message, including the user defined rule, from the UE.
A4. Using the rule definition information received in the message from the UE, the AS configures the supplementary service rules that are to be applied for the user.
A5. Subsequently, an AS implementing a conference focus sends an INVITE request towards the user's UE inviting the user to join a conference. The request URI of the INVITE request is set to the address of the user who is invited to the conference, the P-Asserted-Identity header of the INVITE request is set to the conference URI of the conference, and the Contact header of the INVITE request is set to the conference URI of the conference and includes the “isfocus” feature parameter.
A6. Based on the Initial Filter Criteria (IFC) Rules, indicating that the served user is subscribed to the supplementary service, the INVITE request is forwarded to the AS that implements the supplementary service.
A7. Upon receipt of the INVITE request at the AS, the AS processes the rules that have been configured for the user to determine if an action supported by the supplementary service and associated with the rule should be performed in relation to the INVITE request. For example, if the AS is configured to implement the Communications Diversion (CDIV) service, then the AS can use the rule to determine whether or not to re-direct the INVITE request to an identified target. As an alternative example, if the AS is configured to implement the Communication Barring (CB) service, then the AS can use the rule to determine whether or not to reject the INVITE request.

In order to implement the methods described herein, both the User Equipment (UE) and the Application Servers (AS) that implements the supplementary service would be configured so as to allow the user to configure one or more rules for determining if an action supported by the supplementary service and associated with the rule should be performed in relation to a SIP message.

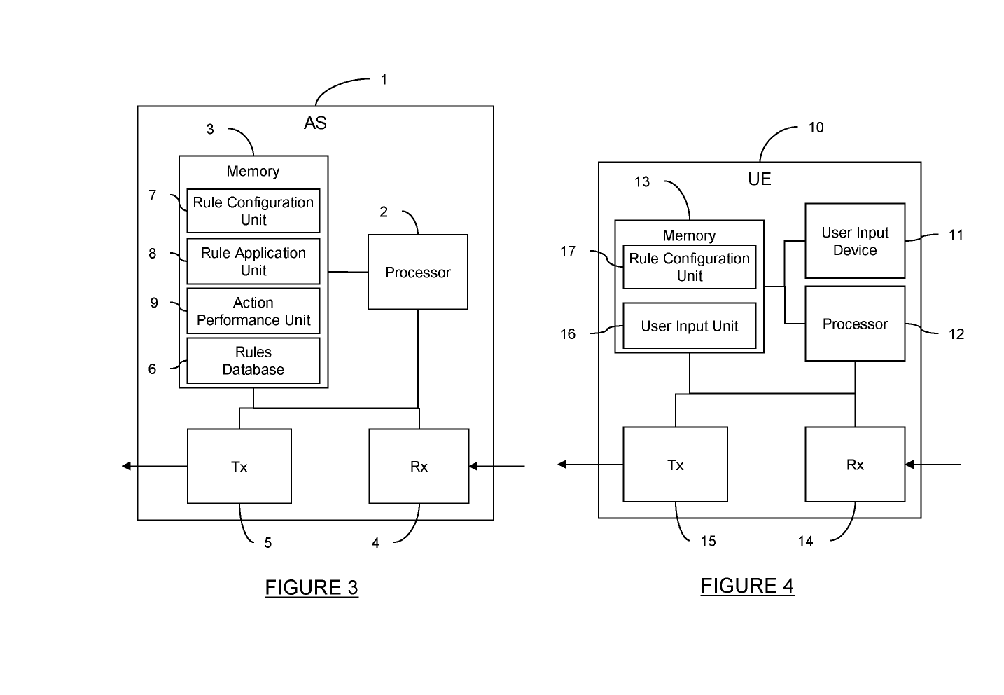

FIG. 3 illustrates schematically an example of an AS 1 for implementing an IMS supplementary service in accordance with the methods described above. The AS 1 can be implemented as a combination of computer hardware and software. The AS 1 comprises a processor 2, a memory 3, a receiver 4 and a transmitter 5. The memory 3 stores the various programs/executable files that are implemented by the processor 2, and also provides a storage unit for any required data. For example, this data can include but is not limited to a rules database 8 that stores the rules configured for the users who have subscribed to the supplementary service. The programs/executable files stored in the memory 3, and implemented by the processor 2, include but are not limited to a rule configuration unit 7, a rule application unit/condition assessment unit 8, and an action performance unit 9. The rule configuration unit 7 can process rule configuration information received from a user in order to configure the rule for the supplementary service that is to be applied for the user. This configuration of the rule would include storing the rule for the user in the rules database 8 provided by the memory 3. When the AS receives a communication relating to the user, using the receiver 4, the rule application unit/condition assessment unit 8 can then access rules database 8 provided by the memory 3 and retrieve the user's rules for the supplementary service. The rule application unit/condition assessment unit 8 can then determine if the condition defined in the rule is met by the communication and thereby determining if an action associated with the rule should be performed in relation to the communication. If it is determined that the action should be performed, then the action performance unit 9 can implement the action defined in the rule for that communication.

FIG. 4 illustrates schematically an example of a UE 10 suitable for implementing the methods described above. The UE 10 can be implemented as a combination of computer hardware and software. The UE 10 comprises a user input device 11, processor 12, a memory 13, a receiver 14 and a transmitter 15. The memory 13 stores the various programs/executable files that are implemented by the processor 12, and also provides a storage unit for any required data. The programs/executable files stored in the memory 13, and implemented by the processor 12, include but are not limited to a user input unit 16, and a rule configuration unit 17. The user input unit 16 can process any user input received from the user input device 11. For example, the user input unit 16 can accept input from the user input device 11 that defines a rule for the user that is to be applied by a supplementary service in accordance with the above-described methods. The user input unit 16 would then provide any user input relating to rule definition/configuration information to the rule configuration unit 17 to allow the user to define such a rule. The rule configuration unit 17 would then ensure that a message is sent to an Application Server (AS) that implements the supplementary service, the message including the rule definition/configuration information defined by the user input.

It will be appreciated by the person of skill in the art that various modifications may be made to the above-described embodiments without departing from the scope of the present invention. For example, whilst the above-described embodiments refer to the use of the generic SIP header field condition for defining a rule that specifies how a supplementary services should handle incoming communications that relate to a conference, this generic SIP header field condition is not limited to this use, and could be used to define any rules that can be applied by a rule-based service. In addition, in order to configure a rule-based supplementary service with rules in accordance with the above-described embodiments, the user could access a web portal/web page provided by the network operator/service provider. The user could then log in and configure their supplementary service settings via the web portal. Of course, the user could access such a web portal using their UE.

1-23. (canceled)

24. A method of operating an Application Server (AS) that implements an Internet Protocol (IP) Multimedia Subsystem (IMS) supplementary service for a user, the method comprising:
receiving a message from the user, the message including a rule defined by user input, the rule having a condition that defines a Session Initiation Protocol (SIP) header field and defines a value of the SIP header field that must be matched n order to meet the condition;
configuring the rule for the user; and
determining if the condition is met by a SIP message and thereby determining if an action associated with the rule should be performed in relation to the SIP message.

25. The method as claimed in claim 24, wherein the supplementary service comprises one of:
a Communications Diversion (CDIV) service;
a Communication Barring (CB) service;
a Flexible Alerting service;
a Flexible Communication Distribution; and
any other rule based service.

26. The method as claimed in claim 24, wherein the rule is configured with a condition that requires the SIP message to have a Contact header field and requires the value of the Contact header field to include an isfocus feature parameter.

27. A method of operating a user equipment (UE) to configure an Internet Protocol (IP) Multimedia Subsystem (IMS) supplementary service for a user, the method comprising:
accepting input from the user, the input defining a rule for the user, the rule having a condition that defines a Session Initiation Protocol (SIP) header field and defines a value of the SIP header field that must be matched by a SIP message in order to meet the condition, and an action to be performed in relation to the SIP message if the condition is met; and
sending a message to an Application Server (AS) that implements the supplementary service, the message including the rule defined by the user input.

28. The method as claimed in claim 27, wherein the supplementary service comprises one of:
a Communications Diversion (CDIV) service;
a Communication Barring (CB) service;
a Flexible Alerting service;
a Flexible Communication Distribution; and
any other rule based service.

29. The method as claimed in claim 27, wherein the rule is configured with a condition that requires the SIP message to have a Contact header field and requires the value of the Contact header field to include an isfocus feature parameter.

30. A method of operating an Internet Protocol (IP) Multimedia Subsystem (IMS) Application Server (AS) that implements a supplementary service for a user, the method comprising:
receiving a message from the user, the message including a rule defined by user input, the rule having a condition specifying whether a Contact header field must include an isfocus feature parameter;
configuring the rule for the user; and
determining if the Contact header field of a Session Initiation Protocol (SIP) message includes the isfocus feature parameter and thereby determining if an action associated with the rule should be performed in relation to the SIP message.

31. The method as claimed in claim 30, wherein the AS is configured to implement one of:
a Communications Diversion (CDIV) service;
a Communication Barring (CB) service;
a Flexible Alerting service;
a Flexible Communication Distribution; and
any other rule based service.

32. The method as claimed in claim 30, wherein the AS is configured to implement a Communications Diversion (CDIV) service, and wherein the rule determines whether to re-direct the SIP message.

33. The method as claimed in claim 30, wherein the AS is configured to implement a Communication Barring (CB) service, and wherein the rule determines whether to reject the SIP message.

34. A method of operating a user equipment (UE) to configure an Internet Protocol (IP) Multimedia Subsystem (IMS) supplementary service for a user, the method comprising:
accepting input from the user, the input defining a rule for the user, the rule having a condition specifying whether a Contact header field of a Session Initiation Protocol (SIP) message must include an isfocus feature parameter, and an action to be performed in relation to the SIP message if the condition is met; and
sending a message to an Application Server (AS) that implements the supplementary service, the message including the rule defined by the user input.

35. The method as claimed in claim 34, wherein the UE is configured to enable the configuration of a supplementary service that comprises one of:
a Communications Diversion (CDIV) service;
a Communication Barring (CB) service;
a Flexible Alerting service;
a Flexible Communication Distribution; and
any other rule based service.

36. The method as claimed in claim 34, wherein the UE is configured to enable the configuration of a Communications Diversion (CDIV) service, and wherein the rule determines whether to re-direct the SIP message.

37. The method as claimed in claim 34, wherein the UE is configured to enable the configuration of a Communication Barring (CB) service, and wherein the rule determines whether to reject the SIP message.

38. An Application Server (AS) configured to implement an Internet Protocol (IP) Multimedia Subsystem (IMS) supplementary service for a user, the AS comprising:
a receiver configured to receive a message from the user, the message including a rule defined by user input, the rule having a condition that defines a Session Initiation Protocol (SIP) header field and defines a value of the SIP header field that must be matched in order to meet the condition;
a memory for storing the rule for the user; and
a processor circuit configured to determine if the condition is met by a SIP message and thereby to determine if an action associated with the rule should be performed in relation to the SIP message.

39. The AS as claimed in claim 38, wherein the AS is configured to implement a supplementary service comprising one of:
a Communications Diversion (CDIV) service;
a Communication Barring (CB) service;
a Flexible Alerting service;
a Flexible Communication Distribution; and
any other rule based service.

40. The AS as claimed in claim 38, wherein the memory is configured with a rule having a condition that requires:
the SIP message have a Contact header field; and
the value of the Contact header field include an isfocus feature parameter.

41. A user equipment (UE) configured to enable a user to access an Internet Protocol (IP) Multimedia Subsystem (IMS), the UE comprising:
a user input circuit configured to receive input from a user;
a processor circuit configured to accept the input from the user input circuit, the input defining a rule for the user to be applied by a supplementary service, the rule having a condition that defines a Session Initiation Protocol (SIP) header field and defines a value of the SIP header field that must be matched in order to meet the condition, and an action to be performed in relation to a SIP message if the condition is met; and
a transmitter configured to send a message to an Application Server (AS) that implements the supplementary service, the message including the rule defined by the user input.

42. The UE as claimed in claim 41, wherein the supplementary service comprises one of:
a Communications Diversion (CDIV) service;
a Communication Barring (CB) service;
a Flexible Alerting service;
a Flexible Communication Distribution; and
any other rule based service.

43. The UE as claimed in claim 41, wherein the processor circuit is further configured to accept the input of the rule having a condition that requires the SIP message to have a Contact header field and requires the value of the Contact header field to include an isfocus feature parameter.

44. An Internet Protocol (IP) Multimedia Subsystem (IMS) Application Server (AS) configured to implement a supplementary service for a user, the IMS AS comprising:
a receiver configured to receive a message from the user, the message including a rule defined by user input, the rule having a condition specifying whether a Contact header field must include an isfocus feature parameter;
a memory for storing the rule for the user; and
a processor circuit configured to determine if the Contact header field of a Session Initiation Protocol (SIP) message includes the isfocus feature parameter as required by the rule and thereby to determine if an action associated with the rule should be performed in relation to the SIP message.

45. The IMS AS as claimed in claim 44, wherein the supplementary service comprises one of:
a Communications Diversion (CDIV) service;
a Communication Barring (CB) service;
a Flexible Alerting service;
a Flexible Communication Distribution; and
any other rule based service.

46. The IMS AS as claimed in claim 44, wherein the IMS AS is configured to implement a Communications Diversion (CDIV) service and the processor circuit is further configured to apply the rule to determine whether to re-direct the SIP message.

47. The IMS AS as claimed in claim 44, wherein the IMS AS is configured to implement a Communication Barring (CB) service and the processor circuit is further configured to apply the rule to determine whether to reject the SIP message.

48. A user equipment (UE) that enables a user to access an Internet Protocol (IP) Multimedia Subsystem (IMS) the UE comprising:
a user input circuit configured to accept input from the user;
a processor circuit configured to accept the input from the user input device, the input defining a rule for the user to be applied by a supplementary service, the rule having a condition specifying whether a Contact header field of a Session Initiation Protocol (SIP) message must include an isfocus feature parameter, and an action to be performed in relation to the SIP message if the condition is met; and
a transmitter configured to send a message to an Application Server (AS) that implements the supplementary service, the message including the rule defined by the user input.
